(19) United States
(12) Patent Application Publication
(10) Pub. No.: US 2025/0047355 A1
(43) Pub. Date: Feb. 6, 2025

(54) PERFORMING CELL MEASUREMENTS USING SPECIFIC NETWORK DEPLOYMENT FLAGS

(71) Applicant: QUALCOMM Incorporated, San Diego, CA (US)

(72) Inventors: Jiaheng LIU, Shanghai (CN); Yong LI, San Diego, CA (US); Jie ZHANG, Shenzhen (CN); Yuxiao HOU, Shenzhen (CN); Kainan LI, Beijing (CN); Zhanyi LIU, Beijing (CN); Raj Kumar NATTHA, San Diego, CA (US); Tom CHIN, San Diego, CA (US); Huan XU, San Diego, CA (US); Jyothi Kiran VATTIKONDA, San Diego, CA (US)

(21) Appl. No.: 18/716,621

(22) PCT Filed: Mar. 2, 2022
(86) PCT No.: PCT/CN2022/078809

§ 371 Date: Jun. 5, 2024

(51) Int. Cl. H04B 7/06; H04W 24/10; H04W 56/00

(52) U.S. Cl. CPC H04B 7/0695; H04W 24/10; H04W 56/0015

(57) ABSTRACT

Various aspects of the present disclosure generally relate to wireless communication. In some aspects, a user equipment (UE) may receive, from a network entity, an absolute threshold synchronization signal block (SSB) consolidation parameter. The TUE may determine whether a threshold value indicated in the absolute threshold SSB consolidation parameter satisfies a predefined value threshold. The UE may set a specific network deployment flag based at least in part on whether the threshold value satisfies the predefined value threshold. The UE may determine a cell measurement result based at least in part on the specific network deployment flag. The UE may perform a downlink beam selection and a beam switch evaluation based at least in part on the specific network deployment flag. Numerous other aspects are described.

### FIELD OF THE DISCLOSURE

Aspects of the present disclosure generally relate to wireless communication and to techniques and apparatuses for performing cell measurements using specific network deployment flags.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Tenn Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, an apparatus for wireless communication at a user equipment (UE) includes a memory and one or more processors, coupled to the memory, configured to: receive, from a network entity, an absolute threshold synchronization signal block (SSB) consolidation parameter; determine whether a threshold value indicated in the absolute threshold SSB consolidation parameter satisfies a predefined value threshold; set a specific network deployment flag based at least in part on whether the threshold value satisfies the predefined value threshold; determine a cell measurement result based at least in part on the specific network deployment flag; and perform a downlink beam selection and a beam switch evaluation based at least in part on the specific network deployment flag.

In some implementations, a method of wireless communication performed by a UE includes receiving, from a network entity, an absolute threshold SSB consolidation parameter; determining whether a threshold value indicated in the absolute threshold SSB consolidation parameter satisfies a predefined value threshold; setting a specific network deployment flag based at least in part on whether the threshold value satisfies the predefined value threshold; determining a cell measurement result based at least in part on the specific network deployment flag; and performing a downlink beam selection and a beam switch evaluation based at least in part on the specific network deployment flag.

In some implementations, a non-transitory computer-readable medium storing a set of instructions for wireless communication includes one or more instructions that, when executed by one or more processors of a UE, cause the UE to: receive, from a network entity, an absolute threshold SSB consolidation parameter; determine whether a threshold value indicated in the absolute threshold SSB consolidation parameter satisfies a predefined value threshold; set a specific network deployment flag based at least in part on whether the threshold value satisfies the predefined value threshold; determine a cell measurement result based at least in part on the specific network deployment flag; and perform a downlink beam selection and a beam switch evaluation based at least in part on the specific network deployment flag.

In some implementations, an apparatus for wireless communication includes means for receiving, from a network entity, an absolute threshold SSB consolidation parameter; means for determining whether a threshold value indicated in the absolute threshold SSB consolidation parameter satisfies a predefined value threshold; means for setting a specific network deployment flag based at least in part on whether the threshold value satisfies the predefined value threshold; means for determining a cell measurement result based at least in part on the specific network deployment flag; and means for performing a downlink beam selection and a beam switch evaluation based at least in part on the specific network deployment flag.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of different synchronization signal blocks (SSBs) for ground area coverage and building coverage, in accordance with the present disclosure.

FIG. 4 is a diagram illustrating an example associated with performing cell measurements using specific network deployment flags, in accordance with the present disclosure.

FIG. 5 is a diagram illustrating an example process associated with performing cell measurements using specific network deployment flags, in accordance with the present disclosure.

FIG. 6 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

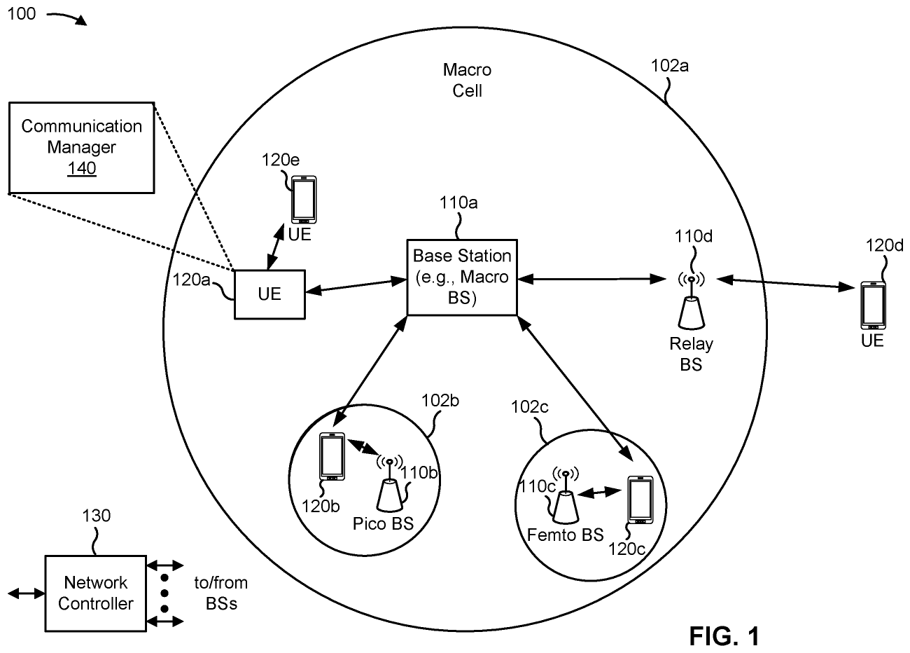

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some aspects, the term “base station” (e.g., the base station 110) or “network entity” may refer to an aggregated base station, a disaggregated base station, an integrated access and backhaul (IAB) node, a relay node, and/or one or more components thereof. For example, in some aspects, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station” or “network entity” may refer to one device configured to perform one or more functions, such as those described herein in connection with the base station 110. In some aspects, the term “base station” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station” or “network entity” may refer to any one or more of those different devices. In some aspects, the term “base station” or “network entity” may refer to one or more virtual base stations and/or one or more virtual base station functions. For example, in some aspects, two or more base station functions may be instantiated on a single device. In some aspects, the term “base station” or “network entity” may refer to one of the base station functions and not another. In this way, a single device may include more than one base station.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., UE 120) may include a communication manager 140. As described in more detail elsewhere herein, the communication manager 140 may receive, from a network entity, an absolute threshold synchronization signal block (SSB) consolidation parameter; determine whether a threshold value indicated in the absolute threshold SSB consolidation parameter satisfies a predefined value threshold; set a specific network deployment flag based at least in part on whether the threshold value satisfies the predefined value threshold; determine a cell measurement result based at least in part on the specific network deployment flag; and perform a downlink beam selection and a beam switch evaluation based at least in part on the specific network deployment flag. Additionally, or alternatively, the communication manager 140 may perform one or more other operations described herein.

As indicated above, FIG. 1 is provided as an example. Other examples may differ from what is described with regard to FIG. 1.

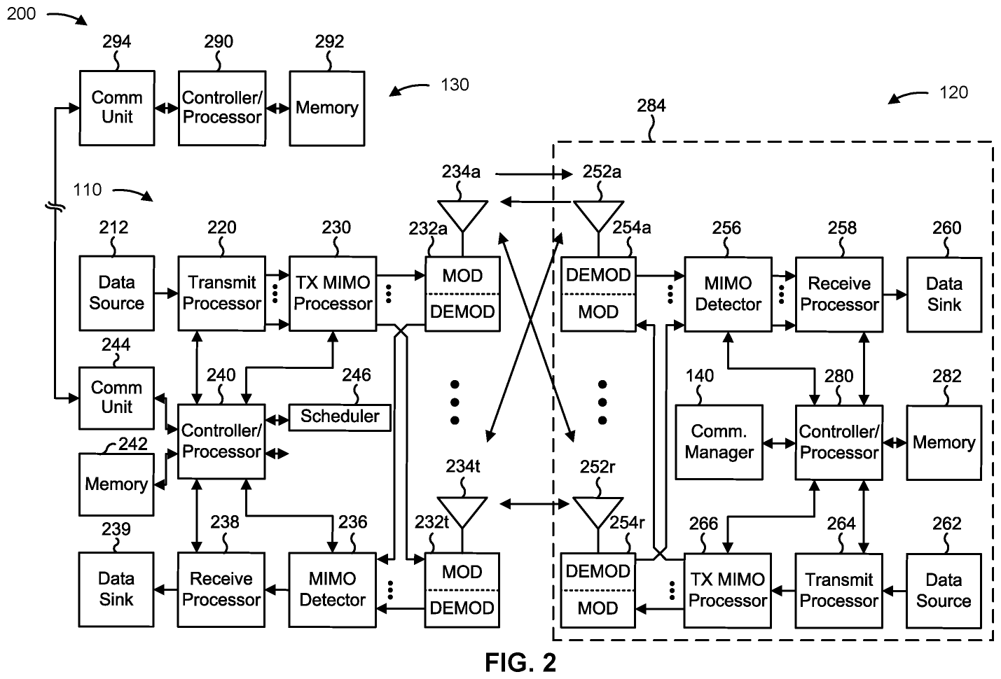

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

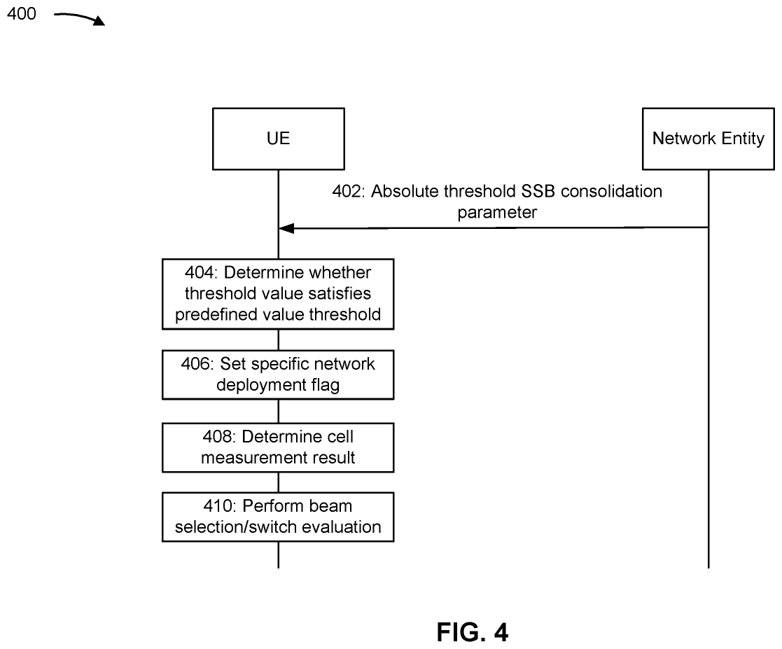

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-6).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-6).

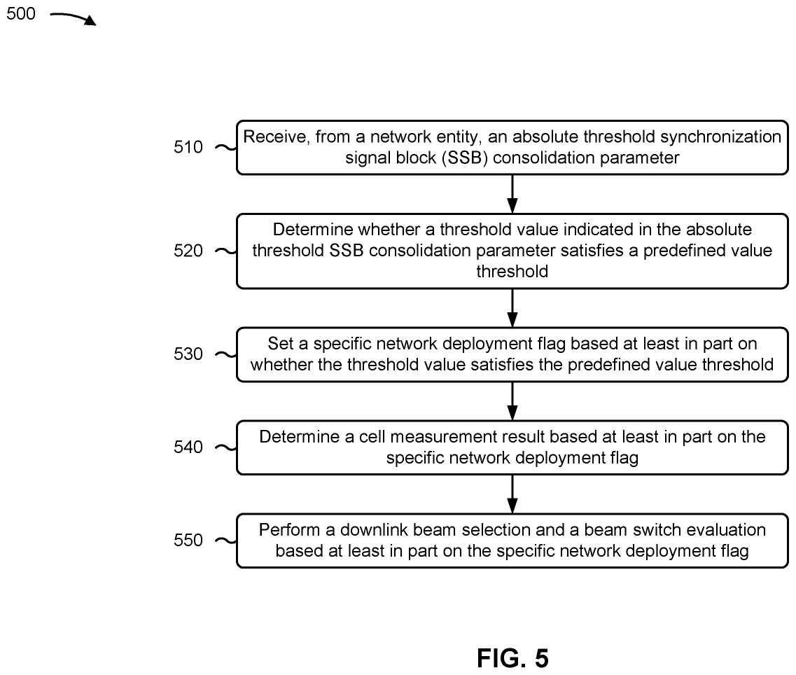

The controller/processor 240 of the base station 110, the controller/processor 280 of the UE 120, and/or any other component(s) of FIG. 2 may perform one or more techniques associated with performing cell measurements using specific network deployment flags, as described in more detail elsewhere herein. For example, the controller/processor 240 of the base station 110, the controller/processor 280 of the UE 120, and/or any other component(s) of FIG. 2 may perform or direct operations of, for example, process 500 of FIG. 5, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 500 of FIG. 5, and/or other processes as described herein. In some examples, executing instructions may include running the instructions, converting the instructions, compiling the instructions, and/or interpreting the instructions, among other examples.

In some aspects, a UE (e.g., UE 120) includes means for receiving, from a network entity, an absolute threshold SSB consolidation parameter; means for determining whether a threshold value indicated in the absolute threshold SSB consolidation parameter satisfies a predefined value threshold; means for setting a specific network deployment flag based at least in part on whether the threshold value satisfies the predefined value threshold; means for determining a cell measurement result based at least in part on the specific network deployment flag; and/or means for performing a downlink beam selection and a beam switch evaluation based at least in part on the specific network deployment flag. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

In some city locations, a UE may experience a call setup failure, a reselection failure (e.g., the UE may fail to reselect an NR cell), and/or an unexpected reselection from an NR cell to an LTE cell. The UE may experience such failures even though an NR cell associated with the UE may be associated with a favorable RSRP measurement (e.g., an RSRP measurement that satisfies a threshold). Such failures may be experienced by either a first subscription of the UE or a second subscription of the UE.

In one specific type of NR cell deployment, in a same cell, separate SSBs may be used to cover different coverage areas. For example, in the same cell, some SSBs may be radiated to a ground area, and other SSBs may be radiated to a building (e.g., a mall). Different network infrastructure vendors may have different implementations. For example, a first network infrastructure vendor may use a 1+X scheme, in which one (1) SSB may be used for ground area coverage and X SSBs may be used for building coverage. A second network infrastructure vendor may use an M+N scheme, in which M SSBs may be used for ground area coverage and N SSBs may be used for building coverage. The 1 and M SSBs may be associated with a relatively wide beam for large area coverage on the ground with normal power radiation, and the X and N SSBs may be associated with a relatively narrow beam for small area coverage in a building with relatively strong power radiation to reduce obstacle attenuation.

In order to prioritize X or N SSBs in a cell for users in the building, a network may configure certain threshold values (e.g., aggressive threshold values) in an absolute threshold synchronization signal blocks consolidation (absThreshSS-BlocksConsolidation) parameter. As an example, the certain threshold values in the absThreshSS-BlocksConsolidation parameter may include an RSRP threshold value (thresholdRSRP) of 111, an RSRQ threshold value (thresholdRSRQ) of 49, and a signal-to-interference-plus-noise ratio (SINR) threshold value (thresholdSJNR) of 56. The network may configure the absThreshSS-BlocksConsolidation parameter via a system information block 2 (SIB2) or a radio resource control (RRC) configuration. The absThreshSS-BlocksConsolidation parameter may be applicable for intra-frequency cell reselection.

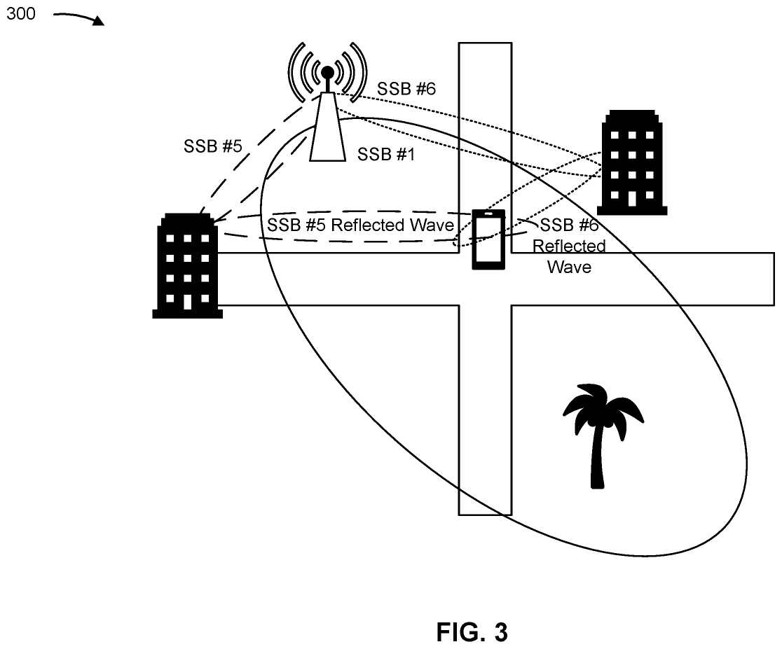

FIG. 3 is a diagram illustrating an example of different SSBs for ground area coverage and building coverage, in accordance with the present disclosure.

As shown in FIG. 3, in a specific network deployment and configuration, a network entity may transmit a first SSB for ground area coverage (e.g., SSB #1), a second SSB for a first building coverage (e.g., SSB #5), and a third SSB for a second building coverage (e.g., SSB #6). A UE on the ground may experience interference from multiple building reflected waves, which may be associated with the second SSB and the third SSB. The UE may receive the first SSB, a reflected wave associated with the second SSB, and a reflected wave associated with the third SSB. Due to a multiple path propagation timing delay of the second SSB and the third SSB, the UE may measure poor signal-to-noise ratios (SNRs) associated with the second SSB and the third SSB, even though the second SSB and the third SSB may be associated with relatively strong RSRPs. As a result, in this specific network deployment and configuration, the UE may derive an incorrect cell level measurement.

As indicated above, FIG. 3 is provided as an example. Other examples may differ from what is described with regard to FIG. 3.

A network entity may configure a UE in an RRC connected state to derive RSRP, RSRQ, and SINR measurement results per cell associated to NR measurement objects based at least in part on parameters configured in a measurement object (measObject) (e.g., a maximum number of beams to be averaged, and beam consolidation thresholds) and in a report configuration (reportConfig). When a highest beam measurement quantity value is below or equal to an absThreshSS-BlocksConsolidation parameter, the UE may derive each cell measurement quantity based at least in part on a synchronization signal (SS) and physical broadcast channel (PBCH) block (SSB) as the highest beam measurement quantity value.

For cell reselection in multi-beam operations, including inter-RAT reselection from Evolved Universal Mobile Telecommunications System (UMTS) Terrestrial Radio Access (E-UTRA) to NR, a cell measurement quantity may be derived amongst beams corresponding to the same cell based at least in part on an SSB. When the highest beam measurement quantity value is below or equal to the absThreshSS-BlocksConsolidation parameter, the UE may derive the cell measurement quantity as the highest beam measurement quantity value.

The UE may derive a cell level measurement result based at least in part on a beam having a beam measurement quantity value that satisfies a threshold (e.g., the absThreshSS-BlocksConsolidation parameter). When no one beam satisfies certain threshold values associated with the absThreshSS-BlocksConsolidation parameter (e.g., thresholdRSRP of 111, thresholdRSRQ of 49, and thresholdSINR of 56), the UE may only pick up a highest measurement quantity beam as the cell level measurement result.

In one scenario, an expected beam “1” or “M” for ground area coverage may be associated with a normal RSRP and a normal SNR (e.g., an RSRP and SNR that satisfy threshold values, and where M refers to SSB(s) for ground area coverage). The UE may measure a beam associated with “X” or “N” with a strong RSRP and a poor SNR (e.g., X and N refer to SSBs for building coverage), which may result in a highest RSRP beam in X or N being selected to derive the cell level measurement result since RSRP may be the only metric to measure cell quality. When a cell is measured with the strong RSRP and the poor SNR, several issues may result. Such issues may involve no cell reselection, call setup failure when a serving beam is on X or N, call reselection failure due to an overestimated cell RSRP and a reselection being triggered too late, and/or a fast cell reselection to LTE (e.g., due to a panic mode) being triggered by a serving cell's poor SNR.

In this scenario, when SSB #1 is associated with a ground area coverage and SSB #5 is associated with a building coverage, SSB #1 may be associated with the normal RSRP and the normal SNR. However, the cell measurement result may be derived from SSB #5, which may be associated with the strong RSRP but the poor SNR. The UE may derive the cell measurement result from SSB #5 instead of SSB #1. As a result, the UE may derive an unexpected cell measurement result.

As an example, SSB #1 may be associated with an RSRP of −90 dBm and an SNR of 10 dB, where the −90 dBm and the 10 dB may be considered typical values. SSB #5 may be associated with an RSRP of −80 dBm and an SNR of −8 dB, where the −80 dBm may be considered a typical value but the −8 dB may be considered a poor value. When a cell measurement result is derived from SSB #5, a serving beam may be associated with SSB #5 instead of SSB #1.

In various aspects of techniques and apparatuses described herein, a UE may receive, from a network entity, an SIB or an RRC configuration. The SIB may be a system information block type 1 (SIB1), a system information block type 2 (SIB2), or a system information block type 4 (SIB4). The SIB or the RRC configuration may indicate a network configuration. The UE may perform a specific network deployment detection based at least in part on the SIB or the RRC configuration. When the SIB or the RRC configuration is applied, the UE may check whether the SIB or the RRC configuration is current in a specific network deployment. The UE may store a detection result in a local database (e.g., a local database for result storage) of the UE. Depending on the detection result (e.g., when the SIB or the RRC configuration is not current in the specific network deployment), the UE may apply or activate a new mechanism for a cell measurement derivation and a beam selection/switch evaluation. The UE may use the new mechanism for the cell measurement derivation and the beam selection/switch evaluation to obtain a cell measurement result. As a result, depending on the specific network deployment (e.g., separate SSBs for ground area coverage and building coverage), the UE may apply the new mechanism for the cell measurement derivation and the beam selection/switch evaluation.

FIG. 4 is a diagram illustrating an example 400 associated with performing cell measurements using specific network deployment flags, in accordance with the present disclosure. As shown in FIG. 4, example 400 includes communication between a UE (e.g., UE 120) and a network entity (e.g., base station 110). In some aspects, the UE and the network entity may be included in a wireless network, such as wireless network 100.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station (BS, e.g., base station 110), or one or more units (or one or more components) performing base station functionality, may be implemented in an aggregated or disaggregated architecture. For example, a BS (such as a Node B (NB), eNB, NR BS, 5G NB, access point (AP), a TRP, a cell, or the like) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual centralized unit (VCU), a virtual distributed unit (VDU), or a virtual radio unit (VRU).

Base station-type operation or network design may consider aggregation characteristics of base station functionality. For example, disaggregated base stations may be utilized in an IAB network, an O-RAN (such as the network configuration sponsored by the O-RAN Alliance), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

As shown by reference number 402, the UE may receive, from the network entity, an absThreshSS-BlocksConsolidation parameter. The UE may receive an SIB during an idle state that indicates the absThreshSS-BlocksConsolidation parameter. The SIB may also indicate an SSB positions in burst (ssb-PositionsInBurst) parameter. Alternatively, the UE may receive an RRC configuration during a connected state that indicates the absThreshSS-BlocksConsolidation parameter. The RRC configuration may indicate the ssb-PositionsInBurst parameter.

In some aspects, the SIB may indicate certain threshold values (e.g., aggressive threshold values, such as thresholdRSRP of 111, thresholdRSRQ of 49, and thresholdSINR of 56), which may be configured for the absThreshSS-BlocksConsolidation parameter indicated in the SIB. In this case, beam selection on X or N SSBs may be prioritized for users in a building. The certain threshold values may be selected to prune a plurality of SSBs (e.g., all SSBs) and only select a highest quality beam when deriving the cell measurement result.

In some aspects, the RRC configuration may indicate a measurement configuration (measConfig), which may configure a certain threshold value (e.g., an aggressive threshold value, such as thresholdRSRP of 111). The certain threshold value may be configured in the measConfig in a connected state for a measObject.

In some aspects, the SIB and the RRC configuration may each indicate the ssb-PositionsInBurst parameter, which may indicate to the UE which SSBs are being transmitted. The ssb-PositionsInBurst parameter may indicate, to the UE, which SSBs (and thereby time domain positions of the SSBs) are being transmitted. The ssb-PositionsInBurst parameter may indicate a bitmap, where a value of “0” may indicate that a corresponding SSB is not transmitted and a value of “1” may indicate that a corresponding SSB is transmitted. The ssb-PositionsInBurst parameter may indicate an SSB pattern, which may indicate a quantity of SSBs for ground area coverage versus a quantity of SSBs for building coverage. The ssb-PositionsInBurst parameter may indicate either a 1+X SSB pattern or an M+N SSB pattern, where the ssb-PositionsInBurst parameter may be associated with an idle state for the SIB and a connected state for the RRC configuration. With respect to the 1+X SSB pattern or the M+N SSB pattern, at least one bitmask “0” (e.g., one or two “0”s) may be between “1” and “X” or “M” and “N” (e.g., 00100100 and 00100111) to define the 1+X SSB pattern or the M+N SSB pattern. For 00100100, which defines 1+X, “001” may correspond to “1”, “00” may correspond to two in-between “0”s, and “100” may correspond to “X”. For 00100111, which defines M+N, “001” may correspond to “M”, “00” may correspond to two in-between “0”s, and “111” may correspond to “N”.

As shown by reference number 404, the UE may determine whether a threshold value indicated in the absolute threshold SSB consolidation parameter satisfies a predefined value threshold. The threshold value may be an RSRP threshold value, an RSRQ threshold value, and/or an SINR threshold value. During the idle state, the UE may determine whether the ssb-PositionsInBurst parameter corresponds to a predefined SSB pattern. The predefined SSB pattern may indicate a quantity of SSBs associated with a ground area coverage and a quantity of SSBs associated with a building coverage. During the connected state, the UE may determine whether the ssb-PositionsInBurst parameter corresponds to the predefined SSB pattern.

As shown by reference number 406, the UE may set a specific network deployment flag based at least in part on whether the threshold value satisfies the predefined value threshold. During the idle state, the specific network deployment flag may be set to “TRUE” for a serving cell frequency based at least in part on the threshold value satisfying the predefined value threshold and the SSB positions in burst parameter corresponding to the predefined SSB pattern, and may otherwise be set to “FALSE”. The specific network deployment flag may be set to “TRUE” for an inter-frequency based at least in part on the threshold value satisfying the predefined value threshold, and may otherwise be set to “FALSE”. The inter-frequency may be associated with a frequency being measured by the UE. During the connected state, the specific network deployment flag may be set to “TRUE” for the serving cell frequency based at least in part on the threshold value satisfying the predefined value threshold and the SSB positions in burst parameter corresponding to the predefined SSB pattern, and may otherwise be set to “FALSE”. The specific network deployment flag may be set to “TRUE” for the inter-frequency based at least in part on the threshold value satisfying the predefined value threshold, and may otherwise be set to “FALSE”.

In some aspects, during a specific network deployment detection, the UE may define a UE configurable threshold for the absThreshSS-BlocksConsolidation parameter. In the idle state, for the serving cell frequency when processing an SIB1 or an SIB2, when a threshold parameter value indicated in the absThreshSS-BlocksConsolidation parameter satisfies a threshold (e.g., is greater than the threshold) and the ssb-PositionsInBurst parameter in the SIB1/SIB2 matches with a 1+X SSB pattern or an M+N SSB pattern, the UE may tag the specific network deployment flag as “TRUE” on the serving cell frequency. The specific network deployment flag may be a serving cell specific network deployment flag. Otherwise, the UE may tag the specific network deployment flag as “FALSE” on the serving cell frequency. In the idle state, for an inter-frequency when processing the SIB4, when a threshold parameter indicated in the absThreshSS-BlocksConsolidation parameter satisfies a threshold (e.g., is greater than the threshold), the UE may tag the specific network deployment flag as “TRUE” on the inter-frequency. Otherwise, the UE may tag the specific network deployment flag as “FALSE” on the inter-frequency.

In some aspects, during the specific network deployment detection, in the connected state, for the serving cell frequency when processing the RRC configuration, when a threshold parameter value indicated in the absThreshSS-BlocksConsolidation parameter satisfies a threshold (e.g., is greater than the threshold) and the ssb-PositionsInBurst parameter matches with a 1+X SSB pattern or an M+N SSB pattern, the UE may tag the specific network deployment flag as “TRUE” on the serving cell frequency. Otherwise, the UE may tag the specific network deployment flag as “FALSE” on the serving cell frequency. In the connected state, for the inter-frequency when processing the measObject indicated in the RRC configuration, when a threshold parameter indicated in the absThreshSS-BlocksConsolidation parameter satisfies a threshold (e.g., is greater than the threshold), the UE may tag the specific network deployment flag as “TRUE” on the inter-frequency. Otherwise, the UE may tag the specific network deployment flag as “FALSE” on the inter-frequency.

In some aspects, setting the network specific deployment flag may involve performing a logic check to determine a processing order, instead of setting the network specific deployment flag as “TRUE” or “FALSE”. In other words, in one implementation, no network specific deployment flag may actually be set, but rather the UE may perform the logic check using the same parameters as used for setting the network specific deployment flag, which may be later used for determining a cell measurement result. For example, based at least in part on the threshold value satisfying the predefined value threshold or not satisfying the predefined value threshold, the UE may determine the cell measurement result.

In some aspects, the UE may store the specific network deployment flag in the local database of the UE. The UE may store the specific network deployment flag for each NR frequency per the idle state and the connected state. In other words, the UE may maintain a storage of the specific network deployment flag for the idle state and the connected state separately.

As shown by reference number 408, the UE may determine the cell measurement result based at least in part on the specific network deployment flag (or based at least in part on the logic check). The UE may query the local database of the UE for the specific network deployment flag. In some aspects, the UE may determine, from the local database, that the specific network deployment flag is set to “TRUE”. The UE may construct, based at least in part on the specific network deployment flag being set to “TRUE”, a candidate SSB pool based at least in part on an SSB measurement result that satisfies one or more UE thresholds. The UE may determine the cell measurement result using the candidate SSB pool, where the cell measurement result may be associated with a measured cell on a frequency. In some aspects, the UE may determine, from the local database, that the specific network deployment flag is set to “FALSE”. The UE may determine the cell measurement result using a full SSB pool. In some aspects, the UE may determine the cell measurement result during the idle state of the UE or during the connected state of the UE. In some aspects, the UE may determine the cell measurement result during a cell selection, a cell reselection, an NR-to-NR reselection, an LTE-to-NR reselection, or a measurement report evaluation.

In some aspects, the UE may apply or activate a new mechanism for a cell measurement derivation and a beam selection/switch evaluation. The UE may perform a cell measurement result processing on each frequency. The UE may query the local database for specific network deployment flags. For each measured cell on a frequency (e.g., a serving cell frequency or an inter-frequency), when the specific network deployment flag is tagged as “TRUE”, the UE may construct the candidate SSB pool. The UE may construct the candidate SSB pool when an SSB measurement result is associated with an RSRP that satisfies a UE RSRP threshold value and an SNR that satisfies a UE SNR threshold value. In other words, the candidate SSB pool may only contain SSBs having RSRPs that satisfy the UE RSRP threshold value and SNRs that satisfy the UE SNR threshold value. The UE RSRP threshold value and the UE SNR threshold value may be configurable at the UE. The UE may derive the cell measurement result from the candidate SSB pool when a candidate SSB number is greater than zero. The UE may derive the cell measurement result from the full SSB pool when the candidate SSB number is zero. When the specific network deployment flag is tagged as “FALSE”, the UE may derive the cell measurement result from the full SSB pool.

In some aspects, the UE may apply the new mechanism for the cell measurement derivation to cell measurement derivations in either the idle state or the connected state. The UE may apply the new mechanisms for various scenarios, such as cell selection, NR-to-NR reselection, LTE-to-NR reselection, and/or measurement report evaluation.

As shown by reference number 410, the UE may perform a downlink beam selection and a beam switch evaluation based at least in part on the specific network deployment flag. The UE may query the local database of the UE for the specific network deployment flag. In some aspects, the UE may determine, from the local database, that the specific network deployment flag is set to “TRUE”. The UE may evaluate a downlink receive beam based at least in part on the downlink receive beam satisfying one or more UE thresholds. In some aspects, the UE may determine, from the local database, that the specific network deployment flag is set to “FALSE”. The UE may evaluate a downlink receive beam on a plurality of measured downlink receive beams.

In some aspects, when performing the downlink receive beam selection and the beam switch evaluation, the UE may query the local database for the specific network deployment flag. When the specific network deployment flag is tagged as “TRUE”, the UE may evaluate the downlink receive beam only when the downlink receive beam satisfies a condition of an RSRP associated with the downlink receive beam satisfying an RSRP threshold value, and an SNR associated with the downlink beam satisfying an SNR threshold value. When the specific network deployment flag is tagged as “FALSE”, the UE may evaluate a best downlink receive beam of the plurality of measured downlink receive beams.

As an example, SSB #1 may be associated with an RSRP of −90 dBm and an SNR of 10 dB, where the −90 dBm and the 10 dB may be considered typical values. SSB #5 may be associated with an RSRP of −80 dBm and an SNR of −8 dB, where the −80 dBm may be considered a typical value but the −8 dB may be considered a poor value. Based at least in part on the specific network deployment detection and the mechanism for deriving the cell measurement result and beam selection/switch evaluation, the cell measurement result may be derived from SSB #1 instead of SSB #5. Further, a serving beam may be associated with SSB #1 instead of SSB #5 (e.g., the other stronger RSRP SSB).

As indicated above, FIG. 4 is provided as an example. Other examples may differ from what is described with regard to FIG. 4.

FIG. 5 is a diagram illustrating an example process 500 performed, for example, by a UE, in accordance with the present disclosure. Example process 500 is an example where the UE (e.g., UE 120) performs operations associated with performing cell measurements using specific network deployment flags.

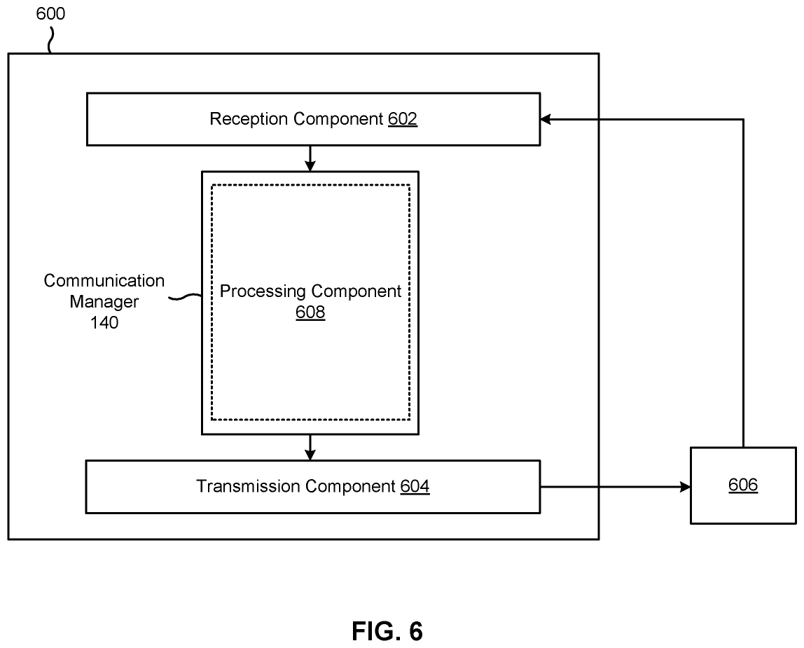

As shown in FIG. 5, in some aspects, process 500 may include receiving, from a network entity, an absolute threshold SSB consolidation (e.g., absThreshSS-BlocksConsolidation) parameter (block 510). For example, the UE (e.g., using communication manager 140 and/or reception component 602, depicted in FIG. 6) may receive, from a network entity, an absolute threshold SSB consolidation parameter, as described above.

As further shown in FIG. 5, in some aspects, process 500 may include determining whether a threshold value indicated in the absolute threshold SSB consolidation parameter satisfies a predefined value threshold (block 520). For example, the UE (e.g., using communication manager 140 and/or processing component 608, depicted in FIG. 6) may determine whether a threshold value indicated in the absolute threshold SSB consolidation parameter satisfies a predefined value threshold, as described above.

As further shown in FIG. 5, in some aspects, process 500 may include setting a specific network deployment flag based at least in part on whether the threshold value satisfies the predefined value threshold (block 530). For example, the UE (e.g., using communication manager 140 and/or processing component 608, depicted in FIG. 6) may set a specific network deployment flag based at least in part on whether the threshold value satisfies the predefined value threshold, as described above.

As further shown in FIG. 5, in some aspects, process 500 may include determining a cell measurement result based at least in part on the specific network deployment flag (block 540). For example, the UE (e.g., using communication manager 140 and/or processing component 608, depicted in FIG. 6) may determine a cell measurement result based at least in part on the specific network deployment flag, as described above.

As further shown in FIG. 5, in some aspects, process 500 may include performing a downlink beam selection and a beam switch evaluation based at least in part on the specific network deployment flag (block 550). For example, the UE (e.g., using communication manager 140 and/or processing component 608, depicted in FIG. 6) may perform a downlink beam selection and a beam switch evaluation based at least in part on the specific network deployment flag, as described above.

Process 500 may include additional aspects, such as any single aspect or any combination of aspects described below and/or in connection with one or more other processes described elsewhere herein.

In a first aspect, process 500 includes receiving, during an idle state of the UE, an SIB that indicates the absThreshSS-BlocksConsolidation parameter.

In a second aspect, alone or in combination with the first aspect, process 500 includes receiving, from the network entity, the SIB, wherein the SIB indicates an ssb-PositionsInBurst parameter; and determining whether the ssb-PositionsInBurst parameter corresponds to a predefined SSB pattern, wherein the predefined SSB pattern indicates a quantity of SSBs associated with a ground area coverage and a quantity of SSBs associated with a building coverage, and the specific network deployment flag is set to “TRUE” for a serving cell frequency based at least in part on the threshold value satisfying the predefined value threshold and the ssb-PositionsInBurst parameter corresponding to the predefined SSB pattern, and is otherwise set to “FALSE”.

In a third aspect, alone or in combination with one or more of the first and second aspects, the specific network deployment flag is set to “TRUE” for an inter-frequency based at least in part on the threshold value satisfying the predefined value threshold, and is otherwise set to “FALSE”.

In a fourth aspect, alone or in combination with one or more of the first through third aspects, process 500 includes receiving, during a connected state of the UE, an RRC configuration that indicates the absThreshSS-BlocksConsolidation parameter.

In a fifth aspect, alone or in combination with one or more of the first through fourth aspects, process 500 includes receiving, from the network entity, the RRC configuration that indicates an ssb-PositionsInBurst parameter; and determining whether the ssb-PositionsInBurst parameter corresponds to a predefined SSB pattern, wherein the predefined SSB pattern indicates a quantity of SSBs associated with a ground area coverage and a quantity of SSBs associated with a building coverage, and the specific network deployment flag is set to “TRUE” for a serving cell frequency based at least in part on the threshold value satisfying the predefined value threshold and the ssb-PositionsInBurst parameter corresponding to the predefined SSB pattern, and is otherwise set to “FALSE”.

In a sixth aspect, alone or in combination with one or more of the first through fifth aspects, the specific network deployment flag is set to “TRUE” for an inter-frequency based at least in part on the threshold value satisfying the predefined value threshold, and is otherwise set to “FALSE”.

In a seventh aspect, alone or in combination with one or more of the first through sixth aspects, process 500 includes storing the specific network deployment flag in a local database of the UE for an NR frequency per idle state and connected state.

In an eighth aspect, alone or in combination with one or more of the first through seventh aspects, process 500 includes querying a local database of the UE for the specific network deployment flag; determining, from the local database, that the specific network deployment flag is set to “TRUE”; constructing, based at least in part on the specific network deployment flag being set to “TRUE”, a candidate SSB pool based at least in part on an SSB measurement result that satisfies one or more UE thresholds; and determining the cell measurement result using the candidate SSB pool, wherein the cell measurement result is associated with a measured cell on a frequency.

In a ninth aspect, alone or in combination with one or more of the first through eighth aspects, process 500 includes querying a local database of the UE for the specific network deployment flag; determining, from the local database, that the specific network deployment flag is set to “FALSE”; and determining the cell measurement result using a full SSB pool, wherein the cell measurement result is associated with a measured cell on a frequency.

In a tenth aspect, alone or in combination with one or more of the first through ninth aspects, the cell measurement result is determined during an idle state of the UE or during a connected state of the UE.

In an eleventh aspect, alone or in combination with one or more of the first through tenth aspects, the cell measurement result is determined during one of a cell selection, a cell reselection, an NR-to-NR reselection, an LTE-to-NR reselection, or a measurement report evaluation.

In a twelfth aspect, alone or in combination with one or more of the first through eleventh aspects, process 500 includes querying a local database of the UE for the specific network deployment flag; determining, from the local database, that the specific network deployment flag is set to “TRUE”; and evaluating a downlink receive beam based at least in part on the downlink receive beam satisfying one or more UE thresholds.

In a thirteenth aspect, alone or in combination with one or more of the first through twelfth aspects, process 500 includes querying a local database of the UE for the specific network deployment flag; determining, from the local database, that the specific network deployment flag is set to “FALSE”; and evaluating a downlink receive beam on a plurality of measured downlink receive beams.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram of an example apparatus 600 for wireless communication. The apparatus 600 may be a UE, or a UE may include the apparatus 600. In some aspects, the apparatus 600 includes a reception component 602 and a transmission component 604, which may be in communication with one another (for example, via one or more buses and/or one or more other components). As shown, the apparatus 600 may communicate with another apparatus 606 (such as a UE, a base station, or another wireless communication device) using the reception component 602 and the transmission component 604. As further shown, the apparatus 600 may include the communication manager 140. The communication manager 140 may include a processing component 608, among other examples.

In some aspects, the apparatus 600 may be configured to perform one or more operations described herein in connection with FIG. 4. Additionally, or alternatively, the apparatus 600 may be configured to perform one or more processes described herein, such as process 500 of FIG. 5. In some aspects, the apparatus 600 and/or one or more components shown in FIG. 6 may include one or more components of the UE described in connection with FIG. 2. Additionally, or alternatively, one or more components shown in FIG. 6 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 602 may receive communications, such as reference signals, control information, data communications, or a combination thereof, from the apparatus 606. The reception component 602 may provide received communications to one or more other components of the apparatus 600. In some aspects, the reception component 602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 600. In some aspects, the reception component 602 may include one or more antennas, a modem, a demodulator, a MIMO detector, a receive processor, a controller/processor, a memory, or a combination thereof, of the UE described in connection with FIG. 2.

The transmission component 604 may transmit communications, such as reference signals, control information, data communications, or a combination thereof, to the apparatus 606. In some aspects, one or more other components of the apparatus 600 may generate communications and may provide the generated communications to the transmission component 604 for transmission to the apparatus 606. In some aspects, the transmission component 604 may perform signal processing on the generated communications (such as filtering, amplification, modulation, digital-to-analog conversion, multiplexing, interleaving, mapping, or encoding, among other examples), and may transmit the processed signals to the apparatus 606. In some aspects, the transmission component 604 may include one or more antennas, a modem, a modulator, a transmit MIMO processor, a transmit processor, a controller/processor, a memory, or a combination thereof, of the UE described in connection with FIG. 2. In some aspects, the transmission component 604 may be co-located with the reception component 602 in a transceiver.

The reception component 602 may receive, from a network entity, an absolute threshold SSB consolidation parameter. The processing component 608 may determine whether a threshold value indicated in the absolute threshold SSB consolidation parameter satisfies a predefined value threshold. The processing component 608 may set a specific network deployment flag based at least in part on whether the threshold value satisfies the predefined value threshold. The processing component 608 may determine a cell measurement result based at least in part on the specific network deployment flag. The processing component 608 may perform a downlink beam selection and a beam switch evaluation based at least in part on the specific network deployment flag.

The number and arrangement of components shown in FIG. 6 are provided as an example. In practice, there may be additional components, fewer components, different components, or differently arranged components than those shown in FIG. 6. Furthermore, two or more components shown in FIG. 6 may be implemented within a single component, or a single component shown in FIG. 6 may be implemented as multiple, distributed components. Additionally, or alternatively, a set of (one or more) components shown in FIG. 6 may perform one or more functions described as being performed by another set of components shown in FIG. 6.

The following provides an overview of some Aspects of the present disclosure:

Aspect 1: A method of wireless communication performed by a user equipment (UE), comprising: receiving, from a network entity, an absolute threshold synchronization signal block (SSB) consolidation parameter; determining whether a threshold value indicated in the absolute threshold SSB consolidation parameter satisfies a predefined value threshold; setting a specific network deployment flag based at least in part on whether the threshold value satisfies the predefined value threshold; determining a cell measurement result based at least in part on the specific network deployment flag; and performing a downlink beam selection and a beam switch evaluation based at least in part on the specific network deployment flag.

Aspect 2: The method of Aspect 1, wherein receiving the absolute threshold SSB consolidation parameter comprises receiving, during an idle state of the UE, a system information block (SIB) that indicates the absolute threshold SSB consolidation parameter.

Aspect 3: The method of Aspect 2, further comprising: receiving, from the network entity, the SIB, wherein the SIB indicates an SSB positions in burst parameter; and determining whether the SSB positions in burst parameter corresponds to a predefined SSB pattern, wherein the predefined SSB pattern indicates a quantity of SSBs associated with a ground area coverage and a quantity of SSBs associated with a building coverage, and wherein the specific network deployment flag is set to “TRUE” for a serving cell frequency based at least in part on the threshold value satisfying the predefined value threshold and the SSB positions in burst parameter corresponding to the predefined SSB pattern, and is otherwise set to “FALSE”.

Aspect 4: The method of Aspect 2, wherein the specific network deployment flag is set to “TRUE” for an inter-frequency based at least in part on the threshold value satisfying the predefined value threshold, and is otherwise set to “FALSE”.

Aspect 5: The method of any of Aspects 1 through 4, wherein receiving the absolute threshold SSB consolidation parameter comprises receiving, during a connected state of the UE, a radio resource control (RRC) configuration that indicates the absolute threshold SSB consolidation parameter.

Aspect 6: The method of Aspect 5, further comprising: receiving, from the network entity, the RRC configuration that indicates an SSB positions in burst parameter; and determining whether the SSB positions in burst parameter corresponds to a predefined SSB pattern, wherein the predefined SSB pattern indicates a quantity of SSBs associated with a ground area coverage and a quantity of SSBs associated with a building coverage, and wherein the specific network deployment flag is set to “TRUE” for a serving cell frequency based at least in part on the threshold value satisfying the predefined value threshold and the SSB positions in burst parameter corresponding to the predefined SSB pattern, and is otherwise set to “FALSE”.

Aspect 7: The method of Aspect 5, wherein the specific network deployment flag is set to “TRUE” for an inter-frequency based at least in part on the threshold value satisfying the predefined value threshold, and is otherwise set to “FALSE”.

Aspect 8: The method of any of Aspects 1 through 7, further comprising: storing the specific network deployment flag in a local database of the UE for a New Radio frequency per idle state and connected state.

Aspect 9: The method of any of Aspects 1 through 8, wherein determining the cell measurement result comprises: querying a local database of the UE for the specific network deployment flag; determining, from the local database, that the specific network deployment flag is set to “TRUE”; constructing, based at least in part on the specific network deployment flag being set to “TRUE”, a candidate SSB pool based at least in part on an SSB measurement result that satisfies one or more UE thresholds; and determining the cell measurement result using the candidate SSB pool, wherein the cell measurement result is associated with a measured cell on a frequency.

Aspect 10: The method of any of Aspects 1 through 9, wherein determining the cell measurement result comprises: querying a local database of the UE for the specific network deployment flag; determining, from the local database, that the specific network deployment flag is set to “FALSE”; and determining the cell measurement result using a full SSB pool, wherein the cell measurement result is associated with a measured cell on a frequency.

Aspect 11: The method of any of Aspects 1 through 10, wherein the cell measurement result is determined during an idle state of the UE or during a connected state of the UE.

Aspect 12: The method of any of Aspects 1 through 11, wherein the cell measurement result is determined during one of: a cell selection, a cell reselection, a New Radio (NR)-to-NR reselection, a Long Term Evolution (LTE)-to-NR reselection, or a measurement report evaluation.

Aspect 13: The method of any of Aspects 1 through 12, wherein performing the downlink beam selection and the beam switch evaluation based at least in part on the specific network deployment flag comprises: querying a local database of the UE for the specific network deployment flag; determining, from the local database, that the specific network deployment flag is set to “TRUE”; and evaluating a downlink receive beam based at least in part on the downlink receive beam satisfying one or more UE thresholds.

Aspect 14: The method of any of Aspects 1 through 13, wherein performing the downlink beam selection and the beam switch evaluation based at least in part on the specific network deployment flag comprises: querying a local database of the UE for the specific network deployment flag; determining, from the local database, that the specific network deployment flag is set to “FALSE”; and evaluating a downlink receive beam on a plurality of measured downlink receive beams.

Aspect 15: An apparatus for wireless communication at a device, comprising a processor; memory coupled with the processor; and instructions stored in the memory and executable by the processor to cause the apparatus to perform the method of one or more of Aspects 1-14.

Aspect 16: A device for wireless communication, comprising a memory and one or more processors coupled to the memory, the one or more processors configured to perform the method of one or more of Aspects 1-14.

Aspect 17: An apparatus for wireless communication, comprising at least one means for performing the method of one or more of Aspects 1-14.

Aspect 18: A non-transitory computer-readable medium storing code for wireless communication, the code comprising instructions executable by a processor to perform the method of one or more of Aspects 1-14.

Aspect 19: A non-transitory computer-readable medium storing a set of instructions for wireless communication, the set of instructions comprising one or more instructions that, when executed by one or more processors of a device, cause the device to perform the method of one or more of Aspects 1-14.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
receive, from a network entity, an absolute threshold synchronization signal block (SSB) consolidation parameter;
determine whether a threshold value indicated in the absolute threshold SSB consolidation parameter satisfies a predefined value threshold;
set a specific network deployment flag based at least in part on whether the threshold value satisfies the predefined value threshold;
determine a cell measurement result based at least in part on the specific network deployment flag; and
perform a downlink beam selection and a beam switch evaluation based at least in part on the specific network deployment flag.

2. The apparatus of claim 1, wherein the one or more processors, to receive the absolute threshold SSB consolidation parameter, are configured to receive, during an idle state of the UE, a system information block (SIB) that indicates the absolute threshold SSB consolidation parameter.

3. The apparatus of claim 2, wherein the one or more processors are further configured to:
receive, from the network entity, the SIB, wherein the SIB indicates an SSB positions in burst parameter; and
determine whether the SSB positions in burst parameter corresponds to a predefined SSB pattern, wherein the predefined SSB pattern indicates a quantity of SSBs associated with a ground area coverage and a quantity of SSBs associated with a building coverage, and
wherein the specific network deployment flag is set to “TRUE” for a serving cell frequency based at least in part on the threshold value satisfying the predefined value threshold and the SSB positions in burst parameter corresponding to the predefined SSB pattern, and is otherwise set to “FALSE”.

4. The apparatus of claim 2, wherein the specific network deployment flag is set to “TRUE” for an inter-frequency based at least in part on the threshold value satisfying the predefined value threshold, and is otherwise set to “FALSE”.

5. The apparatus of claim 1, wherein the one or more processors, to receive the absolute threshold SSB consolidation parameter, are configured to receive, during a connected state of the UE, a radio resource control (RRC) configuration that indicates the absolute threshold SSB consolidation parameter.

6. The apparatus of claim 5, wherein the one or more processors are further configured to:
receive, from the network entity, the RRC configuration that indicates an SSB positions in burst parameter; and
determine whether the SSB positions in burst parameter corresponds to a predefined SSB pattern, wherein the predefined SSB pattern indicates a quantity of SSBs associated with a ground area coverage and a quantity of SSBs associated with a building coverage, and
wherein the specific network deployment flag is set to “TRUE” for a serving cell frequency based at least in part on the threshold value satisfying the predefined value threshold and the SSB positions in burst parameter corresponding to the predefined SSB pattern, and is otherwise set to “FALSE”.

7. The apparatus of claim 5, wherein the specific network deployment flag is set to “TRUE” for an inter-frequency based at least in part on the threshold value satisfying the predefined value threshold, and is otherwise set to “FALSE”.

8. The apparatus of claim 1, wherein the one or more processors are further configured to:
store the specific network deployment flag in a local database of the UE for a New Radio frequency per idle state and connected state.

9. The apparatus of claim 1, wherein the one or more processors, to determine the cell measurement result, are configured to:
query a local database of the UE for the specific network deployment flag;
determine, from the local database, that the specific network deployment flag is set to “TRUE”;
construct, based at least in part on the specific network deployment flag being set to “TRUE”, a candidate SSB pool based at least in part on an SSB measurement result that satisfies one or more UE thresholds; and
determine the cell measurement result using the candidate SSB pool, wherein the cell measurement result is associated with a measured cell on a frequency.

10. The apparatus of claim 1, wherein the one or more processors, to determine the cell measurement result, are configured to:
query a local database of the UE for the specific network deployment flag;
determine, from the local database, that the specific network deployment flag is set to “FALSE”; and
determine the cell measurement result using a full SSB pool, wherein the cell measurement result is associated with a measured cell on a frequency.

11. The apparatus of claim 1, wherein the one or more processors are configured to determine the cell measurement result during an idle state of the UE or during a connected state of the UE.

12. The apparatus of claim 1, wherein the one or more processors are configured to determine the cell measurement result during one of: a cell selection, a cell reselection, a New Radio (NR)-to-NR reselection, a Long Term Evolution (LTE)-to-NR reselection, or a measurement report evaluation.

13. The apparatus of claim 1, wherein the one or more processors, to perform the downlink beam selection and the beam switch evaluation based at least in part on the specific network deployment flag, are configured to:
query a local database of the UE for the specific network deployment flag;
determine, from the local database, that the specific network deployment flag is set to “TRUE”; and
evaluate a downlink receive beam based at least in part on the downlink receive beam satisfying one or more UE thresholds.

14. The apparatus of claim 1, wherein the one or more processors, to perform the downlink beam selection and the beam switch evaluation based at least in part on the specific network deployment flag, are configured to:
query a local database of the UE for the specific network deployment flag;
determine, from the local database, that the specific network deployment flag is set to “FALSE”; and
evaluate a downlink receive beam on a plurality of measured downlink receive beams.

15. A method of wireless communication performed by a user equipment (UE), comprising:
receiving, from a network entity, an absolute threshold synchronization signal block (SSB) consolidation parameter;
determining whether a threshold value indicated in the absolute threshold SSB consolidation parameter satisfies a predefined value threshold;
setting a specific network deployment flag based at least in part on whether the threshold value satisfies the predefined value threshold;
determining a cell measurement result based at least in part on the specific network deployment flag; and
performing a downlink beam selection and a beam switch evaluation based at least in part on the specific network deployment flag.

16. The method of claim 15, wherein receiving the absolute threshold SSB consolidation parameter comprises receiving, during an idle state of the UE, a system information block (SIB) that indicates the absolute threshold SSB consolidation parameter.

17. The method of claim 16, further comprising:
receiving, from the network entity, the SIB, wherein the SIB indicates an SSB positions in burst parameter; and
determining whether the SSB positions in burst parameter corresponds to a predefined SSB pattern, wherein the predefined SSB pattern indicates a quantity of SSBs associated with a ground area coverage and a quantity of SSBs associated with a building coverage, and
wherein the specific network deployment flag is set to “TRUE” for a serving cell frequency based at least in part on the threshold value satisfying the predefined value threshold and the SSB positions in burst parameter corresponding to the predefined SSB pattern, and is otherwise set to “FALSE”.

18. The method of claim 16, wherein the specific network deployment flag is set to “TRUE” for an inter-frequency based at least in part on the threshold value satisfying the predefined value threshold, and is otherwise set to “FALSE”.

19. The method of claim 15, wherein receiving the absolute threshold SSB consolidation parameter comprises receiving, during a connected state of the UE, a radio resource control (RRC) configuration that indicates the absolute threshold SSB consolidation parameter.

20. The method of claim 19, further comprising:
receiving, from the network entity, the RRC configuration that indicates an SSB positions in burst parameter; and
determining whether the SSB positions in burst parameter corresponds to a predefined SSB pattern, wherein the predefined SSB pattern indicates a quantity of SSBs associated with a ground area coverage and a quantity of SSBs associated with a building coverage, and
wherein the specific network deployment flag is set to “TRUE” for a serving cell frequency based at least in part on the threshold value satisfying the predefined value threshold and the SSB positions in burst parameter corresponding to the predefined SSB pattern, and is otherwise set to “FALSE”.

21. The method of claim 19, wherein the specific network deployment flag is set to “TRUE” for an inter-frequency based at least in part on the threshold value satisfying the predefined value threshold, and is otherwise set to “FALSE”.

22. The method of claim 15, further comprising:
storing the specific network deployment flag in a local database of the UE for a New Radio frequency per idle state and connected state.

23. The method of claim 15, wherein determining the cell measurement result comprises:
querying a local database of the UE for the specific network deployment flag;
determining, from the local database, that the specific network deployment flag is set to “TRUE”;
constructing, based at least in part on the specific network deployment flag being set to “TRUE”, a candidate SSB pool based at least in part on an SSB measurement result that satisfies one or more UE thresholds; and
determining the cell measurement result using the candidate SSB pool, wherein the cell measurement result is associated with a measured cell on a frequency.

24. The method of claim 15, wherein determining the cell measurement result comprises:
querying a local database of the UE for the specific network deployment flag;
determining, from the local database, that the specific network deployment flag is set to “FALSE”; and
determining the cell measurement result using a full SSB pool, wherein the cell measurement result is associated with a measured cell on a frequency.

25. The method of claim 15, wherein the cell measurement result is determined during an idle state of the UE or during a connected state of the UE.

26. The method of claim 15, wherein the cell measurement result is determined during one of: a cell selection, a cell reselection, a New Radio (NR)-to-NR reselection, a Long Term Evolution (LTE)-to-NR reselection, or a measurement report evaluation.

27. The method of claim 15, wherein performing the downlink beam selection and the beam switch evaluation based at least in part on the specific network deployment flag comprises:
querying a local database of the UE for the specific network deployment flag;
determining, from the local database, that the specific network deployment flag is set to “TRUE”; and
evaluating a downlink receive beam based at least in part on the downlink receive beam satisfying one or more UE thresholds.

28. The method of claim 15, wherein performing the downlink beam selection and the beam switch evaluation based at least in part on the specific network deployment flag comprises:
querying a local database of the UE for the specific network deployment flag;
determining, from the local database, that the specific network deployment flag is set to “FALSE”; and
evaluating a downlink receive beam on a plurality of measured downlink receive beams.

29. A non-transitory computer-readable medium storing a set of instructions for wireless communication, the set of instructions comprising:
one or more instructions that, when executed by one or more processors of a user equipment (UE), cause the UE to:
receive, from a network entity, an absolute threshold synchronization signal block (SSB) consolidation parameter;
determine whether a threshold value indicated in the absolute threshold SSB consolidation parameter satisfies a predefined value threshold;
set a specific network deployment flag based at least in part on whether the threshold value satisfies the predefined value threshold;
determine a cell measurement result based at least in part on the specific network deployment flag; and
perform a downlink beam selection and a beam switch evaluation based at least in part on the specific network deployment flag.

30. An apparatus for wireless communication, comprising:
means for receiving, from a network entity, an absolute threshold synchronization signal block (SSB) consolidation parameter;
means for determining whether a threshold value indicated in the absolute threshold SSB consolidation parameter satisfies a predefined value threshold;
means for setting a specific network deployment flag based at least in part on whether the threshold value satisfies the predefined value threshold;
means for determining a cell measurement result based at least in part on the specific network deployment flag; and
means for performing a downlink beam selection and a beam switch evaluation based at least in part on the specific network deployment flag.
